(19) United States
(12) Patent Application Publication
(10) Pub. No.: US 2014/0247016 A1
(43) Pub. Date: Sep. 4, 2014

(54) METHOD OF MAKING LITHIUM ION BATTERIES

(71) Applicant: Dow Global Technologies LLC, Midland, MI (US)

(72) Inventors: Alan L. Stottlemyer, Midland, MI (US); Hideaki Maeda, Midland, MI (US); Koichi Numata, Midland, MI (US)

(21) Appl. No.: 14/190,194

(22) Filed: Feb. 26, 2014

Related U.S. Application Data
(60) Provisional application No. 61/772,179, filed on Mar. 4, 2013.

(51) Int. Cl. H01M 10/44; H01M 10/0525

(52) U.S. Cl. CPC H01M 10/446; H01M 10/0525
USPC 320/134; 429/231.95

(57) ABSTRACT

A method for activating lithium ion batteries related to the initial formation cycle (initial battery break in prior to use) is used to improve battery performance. The method involves charging the battery for the first time after being fabricated, to an initial voltage Vᵢ that is above 4.25 Volts vs Li/Li⁺, but less than 5 Volts. The battery is discharged to a base voltage V_{b} that is from 4.15 to 4.25 Volts and held at V_{b} for a period of time that is at least one minute to at most several weeks. The battery is then charged to a final voltage V_{f} that is greater than V_{b}. The batteries activated by the method may have one or more improved properties such as longer cycle life, greater capacity at higher charge/discharge rates or consistent performance from battery to battery.

### FIELD OF THE INVENTION

The invention relates to a method for activating lithium ion batteries related to the initial formation cycle (initial battery break in prior to use). In particular, the invention relates to lithium ion batteries comprised of lithium rich cathode materials where improved battery characteristics may be achieved such as greater cycle life and rate capability.

### BACKGROUND OF THE INVENTION

Lithium ion batteries have over the past couple of decades been used in portable electronic equipment and more recently in hybrid or electric vehicles. Initially, lithium ion batteries first employed lithium cobalt oxide cathodes. Due to expense, toxicological issues and limited energy capacity other cathode materials have or are being developed.

One promising class of materials that has been developed is often referred to as lithium rich layered oxide. These materials generally display a layered structure with monoclinic and rhombohedral domains (two phase) in which initial high specific discharge capacities (˜270 mAh/g) have been achieved when charged to voltages of about 4.6 volts vs Li/Li⁺. Unfortunately, these materials have suffered from a short cycle life. The cycle life is generally taken as the number of cycles (charge-discharge) before reaching a specific capacity such as 80% of the initial specific capacity. Each cycle for these materials is typically between the aforementioned 4.6 volts to 2 volts. These batteries have also suffered from inconsistencies in performance from one battery or cell to another, even though made from the same materials. Likewise, these batteries have not exhibited sufficient ability to retain capacity when charged/discharged at a high rate.

These batteries are initially constructed in the fully discharged state and prior to being used are initially charged (broken in). This initial charging procedure is typically referred to as “formation” or “pretreatment”. Traditionally, formation of lithium ion batteries involved the slow charging of the battery under a small constant current to the desired charge voltage and then maintaining that voltage (hold) for a period of time. Typically, this charge current is equivalent to a current that results in the battery being charged in 20 hours (i.e., C rate of 0.05 (C/20)). Recently, several different formation methods have been disclosed such as in US Pat. Publ. No. 2011/0236751 and J. Power Sources, 183 (2008) 344-346. These methods tend to require long times and yet still may, for example, result in inconsistent performance from battery to battery and insufficient cycle life.

Accordingly, it would be desirable to provide a formation method for forming batteries having cathodes comprised of lithium rich layered metal oxides that results in more consistent performance, improved cycle life and greater energy capacity retention at faster charge/discharge rates compared to the prior art formation methods.

### SUMMARY OF THE INVENTION

We have discovered an improved formation method to initially break in a lithium ion battery comprised of lithium rich layered metal oxide cathodes having one or more of the following: improved cycle life, more consistency from battery to battery, and greater capacity retention at faster charge/discharge rates. The method of the invention comprises:
(A) charging, for the first time after being fabricated, a lithium ion battery comprised of a lithium rich cathode to an initial voltage Vᵢ that is above 4.25 Volts vs Li/Li⁺, but less than 5 Volts;
(B) discharging the lithium ion battery to a base voltage V_{b} that is from 4.15 to 4.25 Volts;
(C) holding the lithium ion battery at V_{b} for a period of time that is at least one minute to at most several weeks; and
(D) charging the lithium ion battery to a final voltage V_{f} that is greater than V_{b}.

It is not completely understood why the method improves the aforementioned properties, but without limiting the invention, it is believed that discharging to the base voltage V_{b} and holding at that voltage results in stabilization of the structure of the lithium rich layered oxide allowing, for example, improved cycle life.

Li/Li⁺ represents the redox potential of the lithium reference electrode, which is defined as 0 volts by convention. Consequently, when using an anode other than Li metal these voltages would be decreased to account for the difference in potential between this other anode and Li metal. Illustratively, a fully charged graphite anode has a potential of about 0.1 V vs Li/Li⁺. Therefore, when charging the cathode in a battery with a graphite anode to 4.25 V vs Li/Li+ the cell voltage will be approximately 4.15 V.

The method of this invention is useful to make the aforementioned batteries for use in any application requiring an electrochemical power source. Examples include transportation (e.g., electric and hybrid vehicles), electronics, power grid load leveling applications and the like.

### BRIEF DESCRIPTION OF THE DRAWINGS

FIG. 1 is a graphical representation of the formation cycle of Example 1 of this invention.

FIG. 2. is a graphical representation of the formation cycle of Example 2 of this invention.

FIG. 3 is a graphical representation of the formation cycle of Example 3 of this invention.

FIG. 4 is a graphical representation of the formation cycle of Example 4 of this invention.

FIG. 5 is a graphical representation of the formation cycle of Comparative Example 1 not of this invention.

FIG. 6 is a graphical representation of the formation cycle of Comparative Example 2 not of this invention.

FIG. 7 is a graphical representation of the formation cycle of Comparative Example 3 not of this invention.

FIG. 8 is a graphical representation of the capacity retention of a battery formed using the method of Example 1 versus a battery formed using the method of Comparative Example 1 at discharge rates of C/10 and 1C (DCH=Discharge in the key).

FIG. 9 is a graphical representation of the capacity retention of a battery formed using the method of Example 2 versus a battery formed using the method of Comparative Example 1 at discharge rates of C/10 and 1C.

FIG. 10 is a graphical representation of the capacity retention of a battery formed using the method of Example 3 versus a battery formed using the method of Comparative Example 1 at discharge rates of C/10 and 1C.

FIG. 11 is a graphical representation of the capacity retention of a battery formed using the method of Example 4 versus a battery formed using the method of Comparative Example 1 at discharge rates of C/10 and 1C.

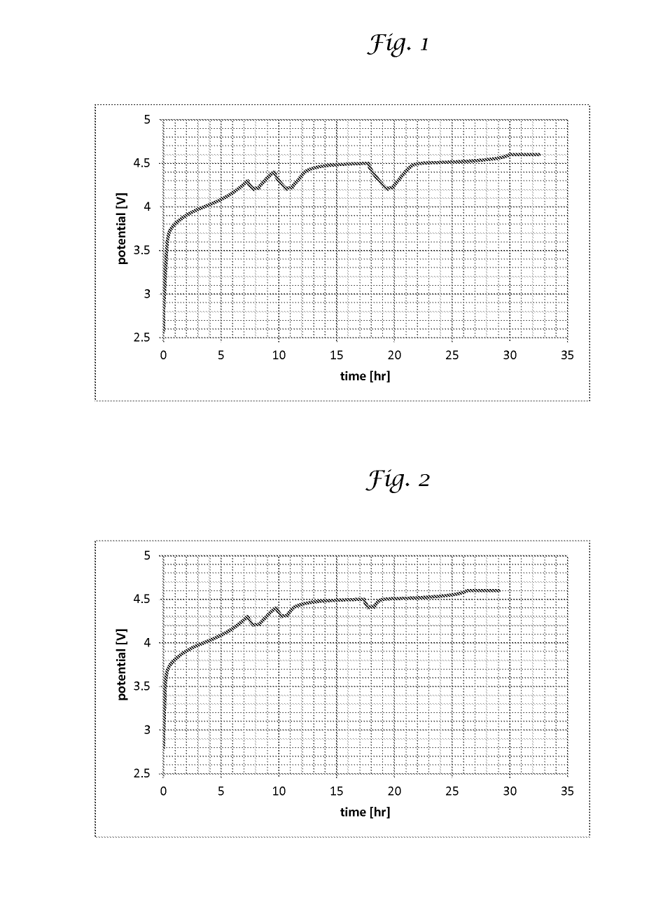

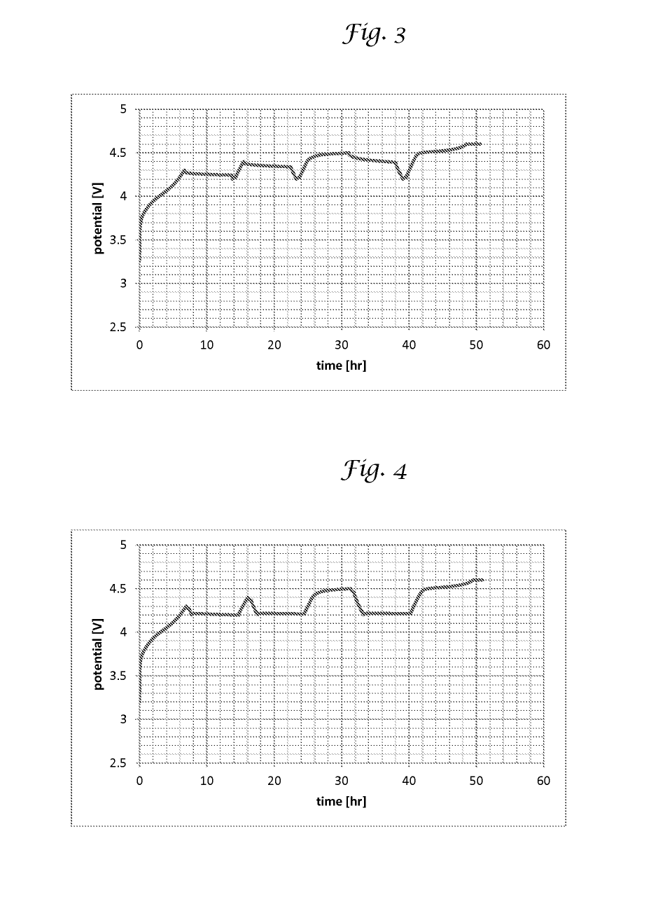

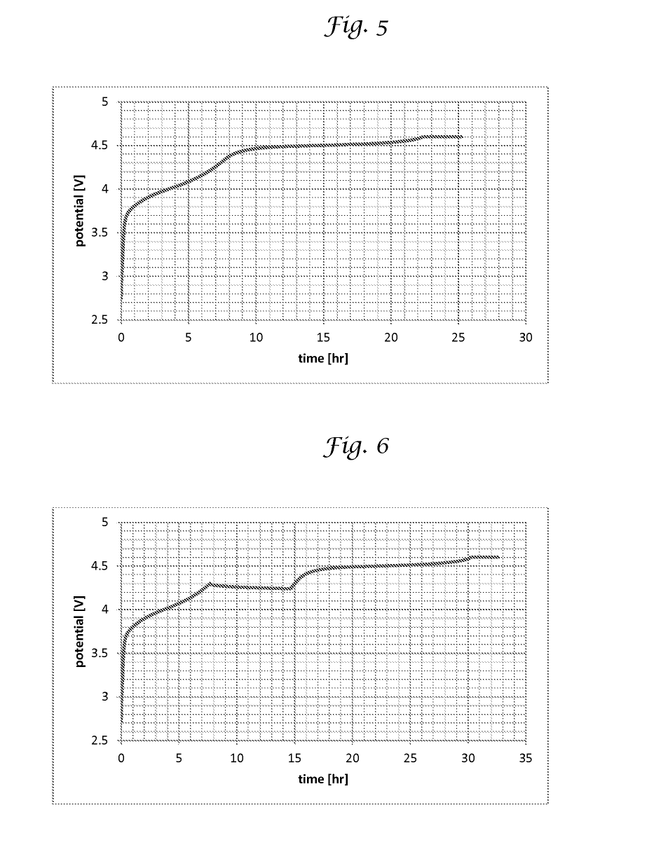

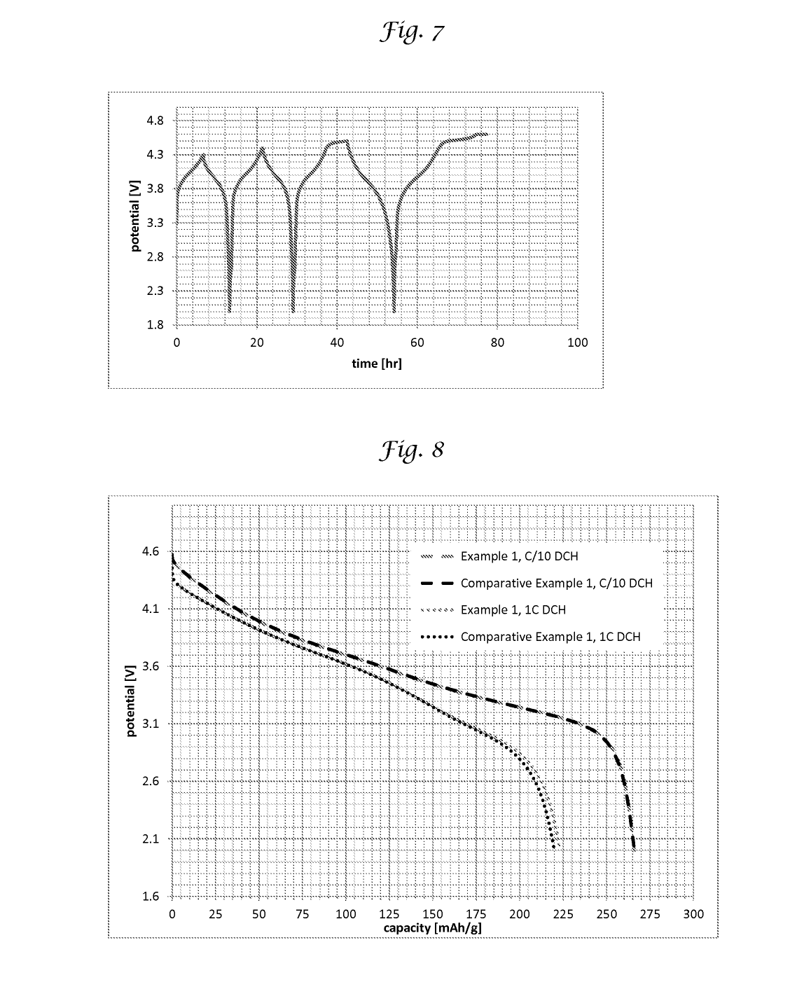

### DETAILED DESCRIPTION OF THE INVENTION

The method of the invention is a formation method for lithium ion batteries comprising a cathode having a lithium rich layered oxide. The lithium rich metal oxide may be any suitable one such as those known in the art. Exemplary lithium rich metal oxides include those described in U.S. Pat. Nos. 5,993,998; 6,677,082; 6,680,143; 7,205,072; and 7,435,402, Japanese Unexamined Pat. No. 11307094A, EP Pat. Appl. No. 1193782; Chem. Mater. 23 (2011) 3614-3621; J. Electrochem. Soc., 145:12, December 1998 (4160-4168). Desirably, the lithium rich layered oxide is a lithium metal oxide wherein the metal is comprised of Mn or Co. Preferably the metal is comprised of Mn and at least one other metal that is a transition metal, rare earth metal or combination thereof or is comprised of LiₓCoO₂ where x is greater than 1 less than 2. More preferably, the metal is comprised of Mn, Ni and Co.

Illustratively, the lithium rich layered metal oxide is represented by a formula:

LiₓM_{y}O₂

Where 1<x<2, y is 1 and the metal may be any metal that has an oxidation state from 2 to 4. Preferably, M is a combination of metals, wherein one of the metals is Ni and it is present in a sufficient amount such that it is present in an oxidation state of at least +2. In a preferred embodiment, M is Ni, Mn and Co such that the composition in Ni_{1-a-b}MnₐCo_{b}, can be described as 0.2≦a≦0.9 and 0≦b≦0.8.

It is understood that the lithium rich layered metal oxides may include dopants of metals at lower levels such as less than 5% by mole without regard to the valence state previously described. It is also understood that these lithium rich layered metal oxides may also contain small amounts of anionic dopants that improve one or more properties such as fluorine. Likewise, the lithium rich layered metal oxides may also be coated with various coatings to improve one or more properties. Exemplary doped and coated materials include those described by U.S. Pat. Nos. 7,205,072 and 8,187,752.

The lithium rich layered metal oxides typically display a specific capacity after being initially charged to 4.6 volts by the traditional formation method described above of at least about 250 mAh/g when discharged at a C rate of 0.05 between 2 and 4.6 volts. A C rate of 1 means charging or discharging in 1 hour between the aforementioned voltages and a C/10 is a rate where the charging or discharging equals 10 hours and a 10C rate is equal to 6 minutes.

The lithium ion battery comprised of a cathode having the lithium rich layered metal oxide may have any suitable design. Such a battery typically comprises, in addition to the cathode, an anode, a porous separator disposed between the anode and cathode, and an electrolyte solution in contact with the anode and cathode. The electrolyte solution comprises a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for making them are described, for example, in U.S. Pat. No. 7,169,511. Other suitable anode materials include lithium metal, lithium alloys, other lithium compounds such as lithium titanate and metal oxides such as TiO₂, SnO₂ and SiO₂, as well as materials such as Si, Sn, or Sb. The anode may be made using one or more suitable anode materials.

The separator is generally a non-conductive material. It should not be reactive with or soluble in the electrolyte solution or any of the components of the electrolyte solution under operating conditions but must allow lithium ionic transport between the anode and cathode. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium salts such as LiAsF₆, LiPF₆, LiPF₄(C₂O₄), LiPF₂ (C₂O₄)₂, LiBF₄, LiB (C₂O₄)₂, LiBF₂(C₂O₄), LiClO₄, LiBrO₄, LiIO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethylene carbonate; a dialkyl carbonate such as diethyl carbonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atoms, and the like.

After the battery is constructed, the battery is subjected to the formation method of this invention. Any suitable apparatus for conducting charging and discharging of the battery may be used such as those known in the art.

The charging and discharging current used in the formation method may be any one that is suitable. Typically, the charging or discharging is at a rate sufficiently slow to avoid incomplete charging or damage to the cell. Generally, the charging and discharging rate is at most about C/10 and commonly is C/20.

The method comprises charging for the first time after being fabricated, to an initial voltage Vᵢ that is above 4.25 Volts vs Li/Li⁺, but less than 5 Volts. It is generally desirable for Vi to be at least 4.3, 4.4, 4.5 or even 4.6 volts.

Once at Vᵢ, the voltage Vᵢ may be maintained for a period of time by introduction of an appropriate current and/or potential by the charging apparatus, such techniques being well known in the art. Alternatively, once Vᵢ has been attained, the battery may be allowed to rest without any introduction of current into the battery, which will result in a small decrease in the voltage of the battery that will plateau at a slightly lower voltage than Vᵢ. It is also understood that once Vᵢ has been attained, any combinations of rests and holds maybe performed. The time period of any hold or rest may be from a minute to weeks, but generally the time is from 1 minute to 10 hours, 7 hours, 5 hours, 2 hours or 1 hour.

After reaching Vᵢ, the battery is then discharged to a base voltage V_{b} by applying a load such that the discharge rate is as described above. V_{b} is from 4.15 to 4.25 volts. At V_{b} the battery is held at V_{b} (voltage between 4.15 to 4.25 volts) for a period of time as described above for the times described for holding at Vᵢ. It is understood that the hold at V_{b} may involve application of an external potential/current as described above or allowed to rest so long as the voltage is maintained at V_{b} (i.e., 4.15 to 4.25 volts).

After holding at V_{b}, the battery is charged to a final voltage V_{f}. V_{f} maybe any voltage exceeding V_{b} (greater than 4.25 volts to 5 volts. It is generally desirable that V_{f} is greater than Vᵢ.

In the practice of the method, it may be desirable prior to charging to V_{f} to have one or more further charging/discharging cycles from V_{b} to a further charging voltage. The further charging voltage is one that is greater than V_{b}, but less than 5 volts. The further charging voltage desirably is equal to or greater than Vᵢ. It is also desirable for each further charging voltage to be equal to or greater than any predecessor further charging voltage when 2 or more charging voltage cycles are employed. At each further charging voltage, there may be a hold or rest as described above. It is understood that upon discharging from the further charging voltage to V_{b}, V_{b} is held as described above.

### EXAMPLES

Each of the Examples and Comparative Examples employed the same lithium rich layered metal oxide (LRLMO) having the chemical formula Li_{1.2}(Ni_{0.17}Mn_{0.56}Co_{0.07})O₂. The LRLMO was prepared from the corresponding coprecipitated transition metal precursor by known techniques.

Each of the coin cells were manufactured in the same way. The LRLMO was mixed with SUPER P™ carbon black (Timcal Americas Inc. Westlake, Ohio), VGCF™ vapor grown carbon fiber (Showa Denko K.K. Japan) and polyvinylidene fluoride (PVdF) (Arkema inc., King of Prussia, Pa.) binder in a weight ratio of LRLMO:SuperP:VGCF:PVdF of 90:2.5:2.5:5. A slurry was prepared by suspending the cathode material, conducting material, and binder in solvent N-Methyl-2-pyrrolidone (NMP) followed by homogenization in a vacuum speed mixer (Thinky USA, Laguna Hills, Calif.). The NMP to solids ratio was approximately 1.6:1 before defoaming under mild vacuum. The slurry was coated on to battery grade aluminum foil using a doctor blade to an approximate thickness of 30 micrometers and dried for thirty minutes at 130° C. in a dry convection oven. The aluminum foil was 15 micrometers thick. 2025 type coin cells were made in a dry environment (dew point less than or equal to −40° C.). The electrodes were pressed on a roller press to approximately 17 micrometers resulting in an active material density of between 2.7 to 3.0 g/cc. The cells had a measured loading level of about 5 mg/cm². The electrolyte was ethylene carbonate/dimethyl carbonate/ethyl methyl carbonate (EC:DMC:EMC, 1:1:1 by volume) with 1 M LiPF₆The anode was 200 micrometer thick high purity lithium foil available from Chemetall Foote Corporation, New Providence, N.J. The separator was a commercially available coated separator.

Each of the formation cycles was run on battery testing station Series 4000 from MACCOR, Tulsa, Okla. The particular parameters are shown for each Example and Comparative Example in a Table detailing the formation cycle as well as shown in a corresponding figure. The cells were then cycled in the same manner (C rate of 1) from 4.6 volts to 2 volts. Prior to cycling in the aforementioned manner, the cells were first cycled to determine the initial capacity of the battery at a C rate of 0.05 and then the capacity was also determined, in order thereafter at C rates of 0.1, 0.2 and 1.

### Example 1

Coin cells were subjected to the formation cycle shown in below Table 1.

### Example 2

Coin cells were subjected to the formation cycle shown in below Table 2.

### Example 3

Coin cells were subjected to the formation cycle shown in below Table 3.

### Example 4

Coin cells were subjected to the formation cycle shown in below Table 4.

### Comparative Example 1

Coin cells were subjected to the formation cycle shown in below Table 5. This cycle is typical of formation cycles typical in the art.

### Comparative Example 2

Coin cells were subjected to the formation cycle shown in below Table 6. This cycle mimics the formation cycle described by US Pub. No. 2011/0236751.

### Comparative Example 3

Coin cells were subjected to the formation cycle in below Table 7. This cycle mimics the formation cycle described by A. Ito et.al., Journal of Power Sources, 183 (2008) 344-346.

It was found that Comparative Examples 2 and 3 had nominally the same performance as Comparative Example 1 and as such only comparisons have been detailed between Comparative Example 1 and the Examples.

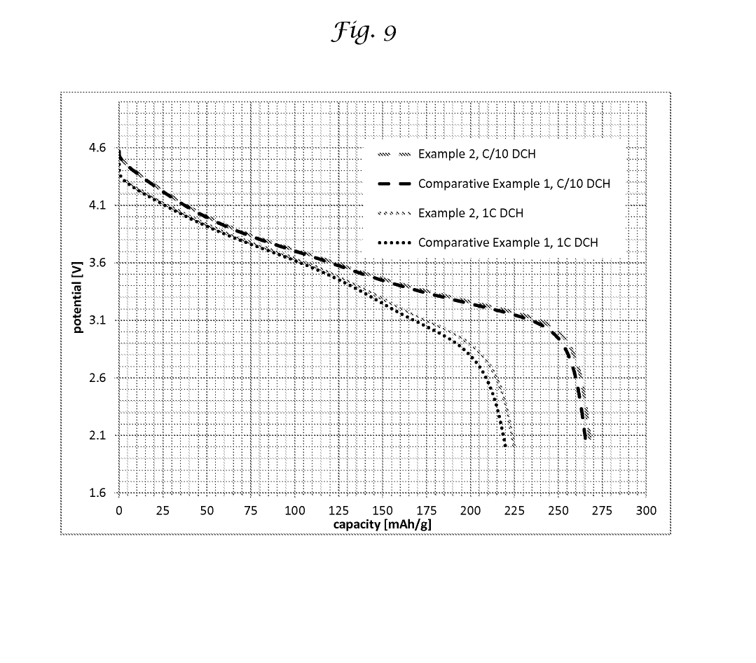

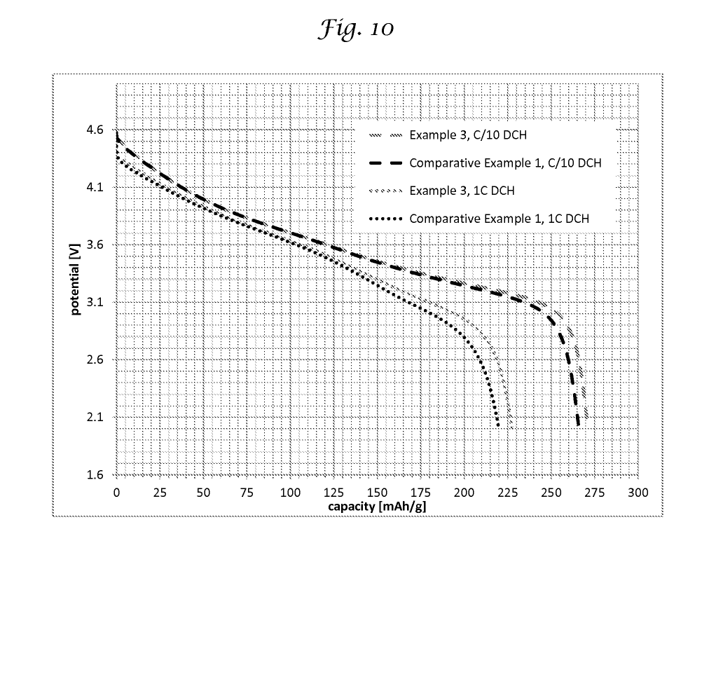

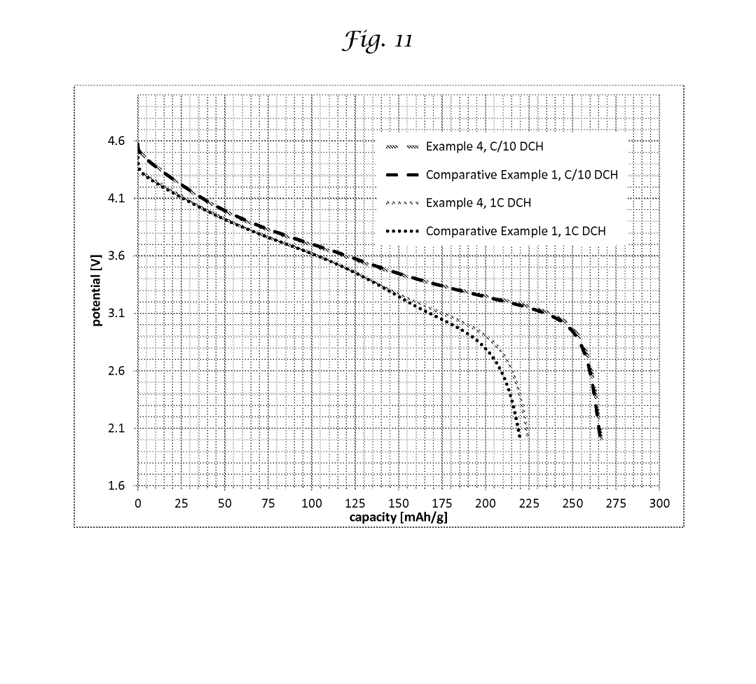

FIGS. 8-11 show the capacity of Examples 1-4 versus Comparative Example 1. This Figure shows that each of the Examples display a higher initial capacity at a discharge rate of 1C than Comparative Example 1. Example 3, in particular had the highest initial capacity at a discharge rate of 1C. Even though not shown, each of the batteries using the formation cycles of Examples 1-4 resulted in improved consistency from one battery to another and also reduced variation from one lot of cathode powder to another compared to batteries treated with the formation cycles of the Comparative Examples. Likewise, batteries made using the formation methods of Examples 3 and 4 displayed improved cycle life.

TABLE 1

| Step | Type | Mode | Val | Limit | Val | End Type | Op | Val |
|---|---|---|---|---|---|---|---|---|
| 1 | Rest | | | | | Step Time | = | 12:00:00 |
| 2 | Do 1 | | | | | | | |
| 3 | Charge | Current | 0.05C | Voltage | 4.3 | Voltage | >= | 4.3 |
| 4 | Rest | | | | | Step Time | = | 00:05:00 |
| 5 | Dischrge | Current | 0.05C | Voltage | 4.2 | Voltage | <= | 4.2 |
| 6 | Rest | | | | | Step Time | = | 00:30:00 |
| 7 | Charge | Current | 0.05C | Voltage | 4.4 | Voltage | >= | 4.4 |
| 8 | Rest | | | | | Step Time | = | 00:05:00 |
| 9 | Dischrge | Current | 0.05C | Voltage | 4.2 | Voltage | <= | 4.2 |
| 10 | Rest | | | | | StepTime | = | 00:30:00 |
| 11 | Charge | Current | 0.05C | Voltage | 4.5 | Voltage | >= | 4.5 |
| 12 | Rest | | | | | StepTime | = | 00:05:00 |
| 13 | Dischrge | Current | 0.05C | Voltage | 4.2 | Voltage | <= | 4.2 |
| 14 | Rest | | | | | StepTime | = | 00:30:00 |
| 15 | Charge | Current | 0.05C | Voltage | 4.6 | Voltage | >= | 4.6 |
| 16 | Charge | Voltage | 4.6 | Current | 1.0 | Current | <= | 0.01C |
| 17 | Rest | | | | | StepTime | = | 00:30:00 |
| 18 | Dischrge | Current | 0.05C | Voltage | 2.0 | Voltage | <= | 2.0 |
| 19 | Rest | | | | | StepTime | = | 00:05:00 |

TABLE 2

| Step | Type | Mode | Val | Limit | Val | End Type | Op | Val |
|---|---|---|---|---|---|---|---|---|
| 1 | Rest | | | | | Step Time | = | 12:00:00 |
| 2 | Do 1 | | | | | | | |
| 3 | Charge | Current | 0.05C | Voltage | 4.3 | Voltage | >= | 4.3 |
| 4 | Rest | | | | | StepTime | = | 00:05:00 |
| 5 | Dischrge | Current | 0.05C | Voltage | 4.2 | Voltage | <= | 4.2 |
| 6 | Rest | | | | | StepTime | = | 00:30:00 |
| 7 | Charge | Current | 0.05C | Voltage | 4.4 | Voltage | >= | 4.4 |
| 8 | Rest | | | | | StepTime | = | 00:05:00 |
| 9 | Dischrge | Current | 0.05C | Voltage | 4.3 | Voltage | <= | 4.3 |
| 10 | Rest | | | | | StepTime | = | 00:30:00 |
| 11 | Charge | Current | 0.05C | Voltage | 4.5 | Voltage | >= | 4.5 |
| 12 | Rest | | | | | StepTime | = | 00:05:00 |
| 13 | Dischrge | Current | 0.05C | Voltage | 4.4 | Voltage | <= | 4.4 |
| 14 | Rest | | | | | StepTime | = | 00:30:00 |
| 15 | Charge | Current | 0.05C | Voltage | 4.6 | Voltage | >= | 4.6 |
| 16 | Charge | Voltage | 4.6 | Current | 1.0 | Current | <= | 0.01C |
| 17 | Rest | | | | | StepTime | = | 00:30:00 |
| 18 | Dischrge | Current | 0.05C | Voltage | 2.0 | Voltage | <= | 2.0 |
| 19 | Rest | | | | | StepTime | = | 00:05:00 |

TABLE 3

| Step | Type | Mode | Val | Limit | Val | End Type | Op | Val |
|---|---|---|---|---|---|---|---|---|
| 1 | Rest | | | | | StepTime | = | 12:00:00 |
| 2 | Do 1 | | | | | | | |
| 3 | Charge | Current | 0.05C | Voltage | 4.3 | Voltage | >= | 4.3 |
| 4 | Rest | | | | | StepTime | = | 07:00:00 |
| 5 | Dischrge | Current | 0.05C | Voltage | 4.2 | Voltage | <= | 4.2 |
| 6 | Rest | | | | | StepTime | = | 00:30:00 |
| 7 | Charge | Current | 0.05C | Voltage | 4.4 | Voltage | >= | 4.4 |
| 8 | Rest | | | | | StepTime | = | 07:00:00 |
| 9 | Dischrge | Current | 0.05C | Voltage | 4.2 | Voltage | <= | 4.2 |
| 10 | Rest | | | | | StepTime | = | 00:30:00 |
| 11 | Charge | Current | 0.05C | Voltage | 4.5 | Voltage | >= | 4.5 |
| 12 | Rest | | | | | StepTime | = | 07:00:00 |
| 13 | Dischrge | Current | 0.05C | Voltage | 4.2 | Voltage | <= | 4.2 |
| 14 | Rest | | | | | StepTime | = | 00:30:00 |
| 15 | Charge | Current | 0.05C | Voltage | 4.6 | Voltage | >= | 4.6 |
| 16 | Charge | Voltage | 4.6 | Current | 1.0 | Current | <= | 0.01C |
| 17 | Rest | | | | | StepTime | = | 00:30:00 |
| 18 | Dischrge | Current | 0.05C | Voltage | 2.0 | Voltage | <= | 2.0 |
| 19 | Rest | | | | | StepTime | = | 00:05:00 |

TABLE 4

| Step | Type | Mode | Val | Limit | Val | End Type | Op | Val |
|---|---|---|---|---|---|---|---|---|
| 1 | Rest | | | | | StepTime | = | 12:00:00 |
| 2 | Do 1 | | | | | | | |
| 3 | Charge | Current | 0.05C | Voltage | 4.3 | Voltage | >= | 4.3 |
| 4 | Rest | | | | | StepTime | = | 00:30:00 |
| 5 | Dischrge | Current | 0.05C | Voltage | 4.2 | Voltage | <= | 4.2 |
| 6 | Rest | | | | | StepTime | = | 07:00:00 |
| 7 | Charge | Current | 0.05C | Voltage | 4.4 | Voltage | >= | 4.4 |
| 8 | Rest | | | | | StepTime | = | 00:30:00 |
| 9 | Dischrge | Current | 0.05C | Voltage | 4.2 | Voltage | <= | 4.2 |
| 10 | Rest | | | | | StepTime | = | 07:00:00 |
| 11 | Charge | Current | 0.05C | Voltage | 4.5 | Voltage | >= | 4.5 |
| 12 | Rest | | | | | StepTime | = | 00:30:00 |
| 13 | Dischrge | Current | 0.05C | Voltage | 4.2 | Voltage | <= | 4.2 |
| 14 | Rest | | | | | StepTime | = | 07:00:00 |
| 15 | Charge | Current | 0.05C | Voltage | 4.6 | Voltage | >= | 4.6 |
| 16 | Charge | Voltage | 4.6 | Current | 1.0 | Current | <= | 0.01C |
| 17 | Rest | | | | | StepTime | = | 00:30:00 |
| 18 | Dischrge | Current | 0.05C | Voltage | 2.0 | Voltage | <= | 2.0 |
| 19 | Rest | | | | | StepTime | = | 00:05:00 |

TABLE 5

| Step | Type | Mode | Val | Limit | Val | End Type | Op | Val |
|---|---|---|---|---|---|---|---|---|
| 1 | Rest | | | | | StepTime | = | 12:00:00 |
| 2 | Do 1 | | | | | | | |
| 3 | Charge | Current | 0.05C | | | Voltage | >= | 4.6 |
| 4 | Charge | Voltage | 4.6 | | | Current | <= | 0.01C |
| 5 | Rest | | | | | StepTime | = | 00:30:00 |
| 6 | Dischrge | Current | 0.05C | | | Voltage | <= | 2.0 |
| 7 | Rest | | | | | StepTime | = | 00:05:00 |

TABLE 6

| Step | Type | Mode | Val | Limit | Val | End Type | Op | Val |
|---|---|---|---|---|---|---|---|---|
| 1 | Rest | | | | | StepTime | = | 12:00:00 |
| 2 | Do 1 | | | | | | | |
| 3 | Charge | Current | 0.05C | Voltage | 4.3 | Voltage | >= | 4.3 |
| 4 | Rest | | | | | StepTime | = | 07:00:00 |
| 5 | Charge | Current | 0.05C | Voltage | 4.6 | Voltage | >= | 4.6 |
| 6 | Charge | Voltage | 4.6 | Current | 1.0 | Current | <= | 0.1C |
| 7 | Rest | | | | | StepTime | = | 00:30:00 |
| 8 | Dischrge | Current | 0.05C | Voltage | 2.0 | Voltage | <= | 2.0 |
| 9 | Rest | | | | | StepTime | = | 00:05:00 |

TABLE 7

| Step | Type | Mode | Val | Limit | Val | End Type | Op | Val |
|---|---|---|---|---|---|---|---|---|
| 1 | Rest | | | | | StepTime | = | 12:00:00 |
| 2 | Do 1 | | | | | | | |
| 3 | Charge | Current | 0.05C | Voltage | 4.3 | Voltage | >= | 4.3 |
| 4 | Rest | | | | | StepTime | = | 00:05:00 |
| 5 | Dischrge | Current | 0.05C | Voltage | 2.0 | Voltage | <= | 2.0 |
| 6 | Rest | | | | | StepTime | = | 00:30:00 |
| 7 | Charge | Current | 0.05C | Voltage | 4.4 | Voltage | >= | 4.4 |
| 8 | Rest | | | | | StepTime | = | 00:05:00 |
| 9 | Dischrge | Current | 0.05C | Voltage | 2.0 | Voltage | <= | 2.0 |
| 10 | Rest | | | | | StepTime | = | 00:30:00 |
| 11 | Charge | Current | 0.05C | Voltage | 4.5 | Voltage | >= | 4.5 |
| 12 | Rest | | | | | StepTime | = | 00:05:00 |
| 13 | Dischrge | Current | 0.05C | Voltage | 2.0 | Voltage | <= | 2.0 |
| 14 | Rest | | | | | StepTime | = | 00:30:00 |
| 15 | Charge | Current | 0.05C | Voltage | 4.6 | Voltage | >= | 4.6 |
| 16 | Charge | Voltage | 4.6 | Current | 1.0 | Current | <= | 0.01C |
| 17 | Rest | | | | | StepTime | = | 00:30:00 |
| 18 | Dischrge | Current | 0.05C | Voltage | 2.0 | Voltage | <= | 2.0 |
| 19 | Rest | | | | | StepTime | = | 00:05:00 |

What is claimed is:

1. A method of performing the formation cycle of a lithium ion battery, comprising:
(A) charging, for the first time after being fabricated, a lithium ion battery comprised of a lithium rich cathode to an initial voltage Vᵢ that is above 4.25 volts vs Li/Li⁺, but less than 5 volts;
(B) discharging the lithium ion battery to a base voltage V_{b} that is from 4.15 to 4.25 Volts;
(C) holding the lithium ion battery at V_{b} for a period of time that is at least one minute to at most several weeks; and
(D) charging the lithium ion battery to a final voltage V_{f} that is greater than V_{b} and less than 5 volts.

2. The method of claim 1, wherein upon reaching Vᵢ, the battery is held at Vᵢ for a period of time, allowed to rest without any current or voltage applied to the cell for a period of time before discharging to a lower voltage or combination thereof.

3. The method of claim 1, further comprising at least one further charging of the battery from V_{b} to a further charging voltage equal to or higher than Vᵢ and discharging to V_{b} and holding the voltage at V_{b} prior to charging to V_{f}, wherein each further charging voltage is less than 5 Volts.

4. The method of claim 2, wherein there are at least two further chargings of the battery and each subsequent further charging is to a higher further charging voltage than its predecessor further charging voltage.

5. The method of claim 1, wherein upon charging to Vᵢ, the battery is allowed to rest for a period of time from 1 minute to 2 weeks.

6. The method of claim 3, wherein at least one of the further chargings further comprises allowing the battery to rest at the further charging voltage.

7. The method of claim 3, wherein at least one of the further chargings further comprises holding the battery at the further charging voltage for one minute to two weeks.

8. A battery made by the method of claim 1.
